(19) United States
(12) Patent Application Publication
(10) Pub. No.: US 2026/0180186 A1
(43) Pub. Date: Jun. 25, 2026

(54) ANTENNA DEVICE, TRANSMITTER, AND RADAR

(71) Applicant: Furuno Electric Co., Ltd., Nishinomiya-City (JP)

(72) Inventor: Kenichi IIO, Nishinomiya (JP)

(73) Assignee: Furuno Electric Co., Ltd., Nishinomiya-City (JP)

(21) Appl. No.: 19/267,750

(22) Filed: Jul. 14, 2025

(30) Foreign Application Priority Data
Dec. 19, 2024 (JP) 2024-223997

(51) Int. Cl. H01Q 9/04; H01Q 21/08

(52) U.S. Cl. CPC H01Q 9/0457; H01Q 21/08

(57) ABSTRACT

Embodiments of the present disclosure provide an antenna device. The antenna device includes a dielectric substrate and a series-connected patched array antenna. The series-connected patched array antenna includes a plurality of patched antennas aligned in a predetermined direction on the dielectric substrate and connected in series. Also, the series-connected patched array antenna includes a plurality of transmission lines connecting adjacent patched antennas of the plurality of patched antennas. Furthermore, for each patched antenna of the plurality of patched antennas, a width of the patch antenna is different from a width of an adjacent patched antenna, on either side, in the predetermined direction. Also, a plurality of line lengths of the plurality of respective transmission lines varies along the predetermined direction.

### CROSS-REFERENCE TO RELATED APPLICATION

This application claims priority under 35 U.S.C. § 119 to Japanese Patent Application No. 2024-223997, filed on Dec. 19, 2024, the entire disclosure of which is hereby incorporated by reference.

### TECHNICAL FIELD

The present disclosure relates generally to antennas, transmitters, and radars. More specifically, the present disclosure relates to patched array antennas, and transmitters and radars based on the patched array antennas.

### BACKGROUND

It is well known in the art to provide patched array antennas including several antennas arranged in one direction and connected in series. In patched array antennas, there is a standing-wave excitation type which is designed so that standing waves are generated in the entire patch-array antenna. The inventors of the present disclosure have found that in such a patched array antenna, not only the patched array antenna but also a transmission line connected to the patched array antenna is in a resonant state. The resonant state of the transmission line is expected to suppress a phase shift of the patched array antenna and improve directivity in a front direction.

However, it has been found that simply adjusting the length of the transmission line to the half wavelength of a fundamental wave is not sufficient to make the transmission line in a resonant state and that the cause is a disturbance of an electromagnetic field generated in a discontinuity between the patched array antenna and the transmission line.

### SUMMARY

The present disclosure has been made in view of the aforementioned challenges, and an object of the present disclosure is to provide an antenna device, a transmitter, and a radar capable of suppressing the phase shift of a patched array antenna.

In order to solve the aforementioned challenges, an antenna device according to an aspect of the present disclosure includes a dielectric substrate and a series-connected patched array antenna. The series-connected patched array antenna includes a plurality of patched antennas aligned in a predetermined direction on the dielectric substrate and connected in series. Also, the series-connected patched array antenna includes a plurality of transmission lines connecting adjacent patched antennas of the plurality of patched antennas. Furthermore, for each patched antenna of the plurality of patched antennas, a width of the patch antenna is different from a width of an adjacent patched antenna, on either side, in the predetermined direction. Also, a plurality of line lengths of the plurality of respective transmission lines varies along the predetermined direction. The antenna device is able to mitigate electromagnetic field disturbances that occur at the junctions between patched antennas and transmission lines. By having non-uniform patch widths and varying transmission line lengths, the antenna can be designed to compensate for these disturbances. This allows for a more controlled electromagnetic field, leading to improved overall antenna performance, particularly in terms of directivity and beam shape.

In one embodiment, a line length of a transmission line, of the plurality of transmission lines, connecting adjacent patched antennas, of the plurality of patched antennas, is determined in correlation with widths of one or both of the two adjacent patched antennas connected to the transmission line. This allows precise tuning of the resonance of each individual transmission line within the array. By determining the line length based on the widths of the two adjacent patched antennas, the design can account for the specific electromagnetic coupling and discontinuity effects at that particular junction. This leads to a more accurate and efficient matching of the transmission lines to their respective patches, which can reduce signal reflection (improve S11) and enhance power transfer (improve S21), ultimately boosting the antenna's efficiency and gain.

In one embodiment, a line length of a transmission line, of the plurality of transmission lines, connecting adjacent patched antennas, of the plurality of patched antennas, is determined in accordance with a width of a wider patched antenna of the two patched antennas connected to the transmission line. This offers simplicity and targeted compensation for the most significant discontinuity. By focusing on the wider of the two adjacent patched antennas, the design prioritizes compensating for the larger electromagnetic field disturbance. This approach can be more straightforward to implement while still providing substantial benefits in reducing undesirable phase shifts and improving directivity, especially in designs where patch widths vary considerably.

In one embodiment, when a plurality of widths of the plurality of patched antennas increases progressively in the predetermined direction, the plurality of line lengths of the plurality of respective transmission lines are determined to progressively decrease in the predetermined direction. This provides the advantage of optimizing the antenna's performance across its length for specific radiation patterns. When patched antenna widths progressively increase, it implies a designed variation in impedance or coupling along the array. By progressively decreasing the transmission line lengths in correlation, the antenna can maintain consistent phase progression and efficient power distribution throughout the array. This leads to a tighter main lobe and reduced side lobes, enhancing the antenna's directivity in the predetermined direction.

In one embodiment, when a plurality of widths of the plurality of patched antennas decreases progressively in the predetermined direction, the plurality of lengths of the plurality of respective transmission lines are determined to progressively increase in the predetermined direction. This offers the advantage of maintaining optimal performance for a different progressive width distribution. If patched antenna widths progressively decrease, it again indicates a specific design for impedance or coupling. By progressively increasing the transmission line lengths, the antenna ensures proper phase alignment and power transfer. This adaptability allows for versatile antenna designs that can achieve desired radiation characteristics, such as a focused beam or specific sidelobe suppression, depending on the application.

In one embodiment, a length of each transmission line, of the plurality of transmission lines, is shorter than half a wavelength of a fundamental wave by an amount correlated to a width of a patched antenna connected to the transmission line. This offers a direct approach to achieving resonance by compensating for electromagnetic field disturbances. Since these disturbances effectively make a transmission line appear longer to the radio wave, physically shortening the line by an amount correlated to the connected patched antenna width ensures that the effective line length remains at half a wavelength. This leads to improved resonant behavior of the transmission lines, which in turn means better impedance matching and more efficient radiation from the entire array.

In one embodiment, a length of each transmission line, of the plurality of transmission lines, is shorter than half a wavelength of a fundamental wave by an amount correlated to the difference between a width of a patched antenna connected to a first end of the transmission line, in the predetermined direction, and a width of another patched antenna connected to a second end, opposite to the first end, of the transmission line. This offers a more refined and accurate compensation for electromagnetic field disturbances. By correlating the reduction in transmission line length to the difference in widths between the two connected patched antennas, it is acknowledged that the discontinuity effect is influenced by both adjacent patches. This more nuanced approach leads to even more precise resonance of the transmission lines, further minimizing phase errors and resulting in superior directivity and gain.

In one embodiment, a length of a transmission line, of the plurality of transmission lines, is determined to enable resonance with a fundamental wave, based on an S-parameter calculated by using a calculation model. The calculation model includes the transmission line, an input line having a same width as a patched antenna connected to a first end of the transmission line, in the predetermined direction, and an output line having a same width as a patched antenna connected to a second end, opposite to the first end, of the transmission line. This offers an ability to scientifically and precisely determine optimal line lengths based on a rigorous calculation model. By using an S-parameter calculation model that includes the transmission line and input/output lines representing the adjacent patches, engineers can simulate and optimize the design for minimal return loss (S11) at the desired frequency. This allows for highly accurate tuning that accounts for complex electromagnetic interactions, leading to antennas with exceptionally high efficiency and directivity and a reduced need for physical prototyping and iterative adjustments.

In one embodiment, a predetermined number of transmission lines, of the plurality of transmission lines, include a predetermined number of respective curved portions, length of each one of the predetermined number of curved portions is correlated with a line length of a respective transmission line where the each one of the predetermined number of curved portions is provided. This provides an advantage of the advantage of physical design flexibility while maintaining optimized electrical performance. Incorporating curved portions allows for adjusting the physical length of the transmission lines without necessarily increasing the overall linear dimension of the antenna device. This is particularly useful when varying line lengths are required to compensate for electromagnetic effects, but the layout needs to be compact or maintain a certain footprint. It enables more compact designs or designs that fit within specific form factors while still achieving the desired electrical properties.

In one embodiment, a predetermined number of transmission lines, of the plurality of transmission lines, include a predetermined number of respective curved portions configured to maintain equal displacements between adjacent patched antennas, of the plurality of patched antennas. This provides an ability to improve beam width and directivity by ensuring a more uniform radiation aperture. By using curved portions to maintain equal displacements between adjacent patched antennas, despite varying transmission line lengths, the antenna device can present a more consistent radiating surface to the electromagnetic waves. This can lead to a narrower and more focused beam, reducing beam squint and enhancing the overall gain in the desired direction.

According to another aspect of the present disclosure, there is provided a transmitter with the above-mentioned antenna device. By incorporating the above-mentioned antenna device, the transmitter benefits from enhanced efficiency, improved directivity, and reduced signal loss. This translates to a more powerful and precise transmission, which is crucial for applications requiring strong, focused signals over distance.

According to another aspect of the present disclosure, there is provided a radar with the above-mentioned antenna device. A radar system with the above-mentioned antenna device will exhibit superior obstacle detection and collision prevention capabilities. The improved directivity and reduced phase errors mean the radar can more accurately pinpoint targets, distinguish between closely spaced objects, and provide clearer returns. This leads to safer and more reliable operation in applications like onboard radar for vehicles or marine navigation.

### BRIEF DESCRIPTION OF THE DRAWINGS

The following detailed description of illustrative embodiments is better understood when read in conjunction with the appended drawings. To illustrate the present disclosure, exemplary constructions of the disclosure are shown in the drawings. However, the present disclosure is not limited to a specific device, or a tool and instrumentalities disclosed herein. Moreover, those in the art will understand that the drawings are not to scale. Wherever possible, like elements have been indicated by identical numbers:

FIG. 1 is a block diagram illustrating an example configuration of a radar;

FIG. 2 illustrates a conventional configuration of an antenna device, in accordance with conventional art;

FIG. 3 illustrates a series-connected patched array antenna, in accordance with an embodiment of the present disclosure;

FIG. 4 illustrates a graphical representation of a plurality of line lengths of a plurality of respective transmission lines of the series-connected patched array antenna of FIG. 3;

FIG. 5 illustrates a tabular representation of the plurality of line lengths of the plurality of respective transmission lines of the series-connected patched array antenna of FIG. 3;

FIG. 6 illustrates an example of a Calculation Model (CM) for determining a line length of a transmission line, in accordance with an embodiment of the present disclosure;

FIG. 7 illustrates S11 (return loss) and S21 (transmission coefficient) in dB of the CM of FIG. 6;

FIG. 8 illustrates radiation patterns of two different antenna designs, the series-connected patched array antenna of FIG. 3, and the series-connected patched array antenna of FIG. 2, showing their gain (in dB) versus angle (in degrees);

FIG. 9 illustrates a series-connected patched array antenna, in accordance with another embodiment of the present disclosure;

FIG. 10 illustrates a tabular representation of the line lengths of the transmission lines of the series-connected patched array antenna of FIG. 9;

FIG. 11 illustrates a radiation pattern of the series-connected patched array antenna of FIG. 9 and FIG. 10; and

FIG. 12 illustrates a series-connected patched array antenna, in accordance with another embodiment of the present disclosure.

The diagrams are for illustration only, which thus is not a limitation of the present invention. Moreover, those skilled in the art will understand that the drawings are not to scale.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification does not necessarily refer to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

Various embodiments of the present disclosure provide an antenna device, a transmitter, and a radar. The radar, functioning as the transmitter for applications like obstacle detection or marine navigation, includes the antenna device, a transceiver unit, a signal processing unit, and a control unit, with the latter two often integrated as processing circuitry. The transceiver unit, equipped with a modulator and magnetron, generates transmission signals by pulsing the magnetron based on triggers from the signal processing unit. The transmission signals are then transmitted as pulsating radio waves by the antenna device. Upon reflection from a target, the antenna device converts the reflected radio waves into reception signals, which are subsequently processed by a detection circuit of the transceiver unit and a frequency conversion/amplification circuit of the signal processing unit, before being digitized and sent to the control unit.

A conventional antenna device typically consists of a dielectric substrate with a conductor pattern on one surface and a ground pattern on the opposite. The conductor pattern includes a series-connected patched array antenna and an input/output line to power the series-connected patched array antenna. The series-connected patched array antenna is a standing-wave excitation, series-fed type, featuring multiple rectangular patched antennas arranged linearly and connected by transmission lines. The patched antennas are approximately half the wavelength of the fundamental carrier frequency in widths. The input/output line can connect to either an end or a middle feeding point, formed by a through-hole in the substrate. This entire conductor pattern is commonly fabricated using photolithography to pattern a metal foil. Furthermore, the antenna device may incorporate multiple series-connected patched array antennas arranged in the width direction, with some dedicated to transmission and others to reception.

Challenges in conventional designs arise from the resonant state of the transmission lines and electromagnetic field disturbances at the discontinuities between patched antennas and transmission lines, particularly where there are width differences. The electromagnetic field disturbances affect the effective length of the transmission lines and can cause phase shifts, leading to deviations in directivity. To counteract the deviations in directivity, in several embodiments proposed in the present disclosure, the series-connected patched array antenna addresses these issues by adjusting the line lengths of the transmission lines. The line lengths are set such that the greater the width difference between a transmission line and connected patched antennas, the greater the reduction in the line length of the transmission line from half the fundamental wavelength.

This approach results in varying line lengths, with those closer to the center being shorter due to larger width differences in adjacent patched antennas, while those at the edges, where electromagnetic field disturbance is negligible, can maintain lengths substantially equal to half the fundamental wavelength. This strategic adjustment ensures that each transmission line resonates effectively, thereby suppressing phase shifts and significantly improving the directivity of the antenna device by radiating the maximum gain almost directly forward. Furthermore, several embodiments of the present disclosure even incorporate curved portions in the transmission lines to enable equal displacement of patched antennas, further refining beam width, and directivity.

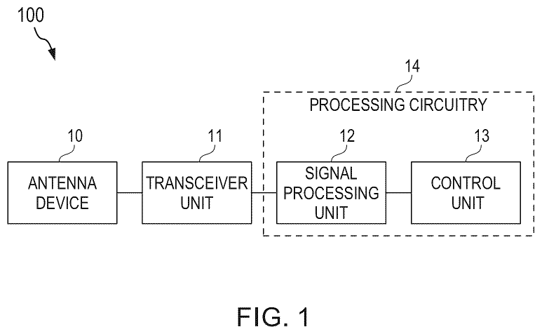

Various embodiments of the present disclosure will now be discussed in detail with reference to FIGS. 1-12.

FIG. 1 is a block diagram illustrating an example configuration of a radar 100. The radar 100 is an example of a transmitter. The radar 100 includes an antenna device 10, a transceiver unit 11, a signal processing unit 12, and a control unit 13. The signal processing unit 12 and the control unit 13 can be implemented as processing circuitry 14. The transceiver unit 11 includes a modulator (not shown) and a magnetron (not shown). The transceiver unit 11 generates a transmission signal by intermittently driving the magnetron with a pulse voltage generated by the modulator in response to a trigger signal from the signal processing unit 12. The antenna device 10 transmits the transmission signal generated by the transceiver 11 as pulsating radio waves. The antenna device 10 converts reflected waves (received after the pulsating radio waves are reflected by a target) into a reception signal. The reception signal received by the antenna device 10 is processed by a detection circuit (not shown) included in the transceiver unit 11 and a frequency conversion/amplification circuit of the signal processing unit 12 and sent to the control unit 13 as a digital signal. This process can be achieved inside of the processing circuitry 14. The radar 100 is applied, for example, to an onboard radar for obstacle detection or collision prevention that transmits and receives millimeter waves. The radar 100 may also be applied, for example, to a marine radar that transmits and receives microwaves.

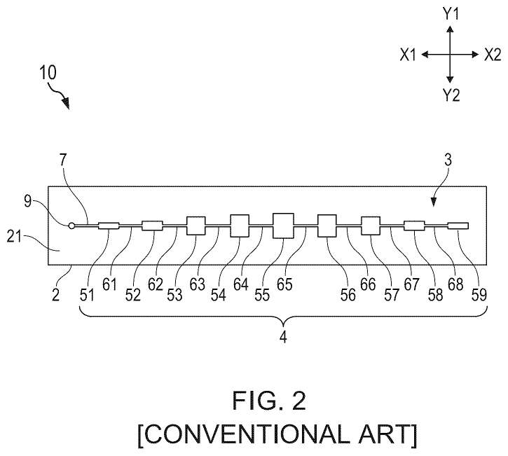

FIG. 2 illustrates a conventional configuration of the antenna device 10, in accordance with conventional art. The antenna device 10 includes a dielectric substrate 2, a conductor pattern 3 formed on a first main surface 21 (a surface visible in FIG. 2) of the dielectric substrate 2, and a ground pattern (not shown) formed on a second main surface opposite to the first main surface 21 of the dielectric substrate 2. The conductor pattern 3 includes a series-connected patched array antenna 4 and an input/output line 7 for supplying power to the series-connected patched array antenna 4. In the context of the disclosure, the phrase “series-connected patched array antenna 4” is a generic phrase representing series-connected patched array antennas 4A to 4C of the embodiments described in the following disclosure.

The series-connected patched array antenna 4 is a standing-wave excitation series-fed patched array antenna. Furthermore, the series-connected patched array antenna 4 includes a plurality of patched antennas 51-59 (also called antenna elements) arranged in one direction (X1-X2) (a length direction). Furthermore, the series-connected patched array antenna 4 includes a plurality of transmission lines 61-68 connecting a plurality of respective pairs of adjacent patched antennas of the plurality of patched antennas 51-59. The number of patched antennas is not limited to the illustrated example configuration of FIG. 2. In that regard, the series-connected patched array antenna 4 may have more or a smaller number of patched antennas than illustrated in FIG. 2.

Furthermore, as illustrated in FIG. 2, in the series-connected patched array antenna 4, a patched antenna (for instance, the patched antenna 51), of the plurality of patched antennas 51-59, and a transmission line (for instance, the transmission line 61), of the plurality of transmission lines 61-68, are arranged alternately in the one direction (X1-X2). Therefore, the antenna device 10 has strong directivity as a whole. The plurality of transmission lines 61-68 are envisaged to be high-impedance lines with higher impedance than the plurality of patched antennas 51-59.

The one direction (X1-X2) shown in FIG. 2 is an arrangement direction of the plurality of patched antennas 51-59, an extension direction of the plurality of transmission lines 61-68, and a transmission direction of the pulsating radio waves in the series-connected patched array antenna 4. Hereinafter, the one direction (X1-X2) may also be referred to as “the length direction” or “the X direction”. In addition, one side of the X direction (in a left portion of FIG. 2) may also be referred to as “the X1 side” and another side opposite to the X1 side (in a right portion of FIG. 2) may also be referred to as “the X2 side”. Furthermore, another direction (Y1-Y2), orthogonal to the X direction, may also be referred to as “the width direction” of the antenna device 10, the plurality of patched antennas 51-59, and the plurality of transmission lines 61-68. Furthermore, hereinafter, the other direction (Y1-Y2) may also be referred to as “the Y direction” or “the width direction”. In addition, one side of the Y direction (in an upper portion of FIG. 2) may also be referred to as “Y1 side” and another side opposite to the Y1 side (in a lower portion of FIG. 2) may also be referred to as “Y2 side”.

Each patched antenna, of the plurality of patched antennas 51-59, is formed in a rectangular shape and has a length in the X direction that is about to one-half (½) of a wavelength of a fundamental wave of a carrier frequency. In other words, the length of each one of the plurality of patched antennas 51-59 is one-half (½) of the wavelength of the fundamental wave. The input/output line 7 is connected to a feeding point 9 to supply power from the feeding point 9 to an end on the X1 side of the series-connected patched array antenna 4 (referred to as “end feed” method). The input/output line 7 may supply power from the feeding point 9 to a middle portion of the series-connected patched array antenna 4 (referred to as “center feed” method). The feeding point 9 is formed by a through-hole formed in the dielectric substrate 2.

The conductor pattern 3 may be formed by patterning a metal foil provided on the first main surface 21 of the dielectric substrate 2 by photolithography. Therefore, the plurality of patched antennas 51-59, the plurality of transmission lines 61-68, and the input/output line 7 are integrally formed. In the example of FIG. 2, only one series-connected patched array antenna 4 has been illustrated, however, in several alternate examples, the antenna device 10 may be provided with a plurality of series-connected patched array antennas 4 arranged in the width direction Y. Further, among the plurality of series-connected patched array antennas 4, a plurality of series-connected patched array antennas 4 may be used for transmission and remaining series-connected patched array antennas 4 may be used for reception.

Furthermore, in the conventional series-connected patched array antenna 4, basically, the plurality of patched antennas 51-59 is arranged at equal intervals and line lengths of a plurality of transmission lines 61-68 are all the same. The inventors of the present disclosure have discovered that in the conventional series-connected patched array antenna 4, the plurality of transmission lines 61-68 connecting the plurality of respective pairs of the patched antennas also are in a resonant state, and for this reason, the influence of a disturbance of an electromagnetic field generated at a discontinuity between a patched antenna (for instance, the patched antenna 52) and a transmission line (for instance, the transmission line 61) should be considered. The disturbance of the electromagnetic field is caused by the difference between the width of the patched antenna 52 and the width of the transmission line 61, and in patched array antennas in which the width of the patched antenna varies depending on the position, the degree of the influence of the electromagnetic field is different.

Moreover, in a patched array antenna, respective lengths of the plurality of transmission lines 61-68 affect the radiation phase of the patched antenna, and if a phase shift occurs in series-connected patched array antenna 4, the directivity in the length direction is deviated. Therefore, by designing a plurality of respective line lengths of the plurality of transmission lines 61-68 as described below, the plurality of transmission lines 61-68 are in a resonant state, and the phase shift of any patched antenna, of the plurality of patched antennas 51-59 is suppressed, and the directivity in the length direction is improved.

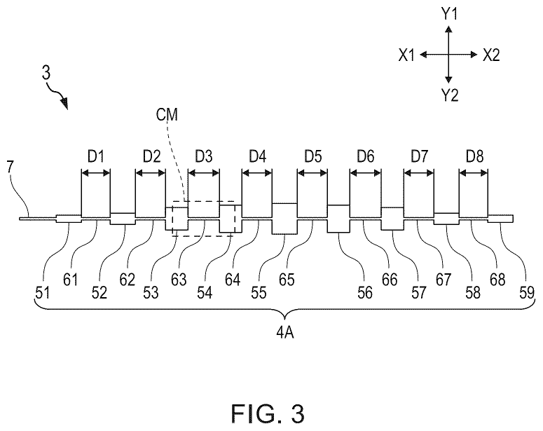

FIG. 3 illustrates a series-connected patched array antenna 4A, in accordance with an embodiment of the present disclosure. In the embodiment described below, it is assumed that the dielectric substrate 2 of the antenna device 10 is made of a material having a relative dielectric constant of 3.35 and a thickness of 0.4 mm. When a 24 GHz radio wave is used, the half wavelength of the fundamental wave corresponds to 6.25 mm. In the series-connected patched array antenna 4A, a plurality of respective line lengths of the plurality of respective transmission lines 61-68 is set so that the larger the difference between the width of the transmission line 61 and the width of the patched antenna 51 or 52 connected to the transmission line 61, the larger the decrease of a line length of the transmission line 61 from the half wavelength of the fundamental wave.

The plurality of patched antennas 51-59 have narrower widths closer to end portions of the series-connected patched array antenna 4A in the X direction, and wider widths closer to the center of the series-connected patched array antenna 4A, in the X direction. Therefore, the plurality of line lengths of the plurality of respective transmission lines 61-68 are longer closer to two end portions of the series-connected patched array antenna 4A in the X direction, and shorter closer to a middle portion of the series-connected patched array antenna 4A in the X direction. The plurality of respective widths of the plurality of transmission lines 61-68 remain constant along the entire lengths of the series-connected patched array antenna 4A in the X-direction.

In other words, the width of the patched antenna 55 in the middle portion of the series-connected patched array antenna 4A, in the X direction, is larger than the widths of the patched antennas 54 and 56 towards the end portions of the series-connected patched array antenna 4A, in the X direction. Similarly, the widths of the patched antennas 54 and 56 are larger than the widths of the patched antennas 53 and 57. The widths of the patched antennas 53 and 57 are larger than the widths of the patched antennas 52 and 58. The widths of the patched antennas 52 and 58 are larger than the widths of the patched antennas 51 and 59 at the edges of the series-connected patched array antenna 4A.

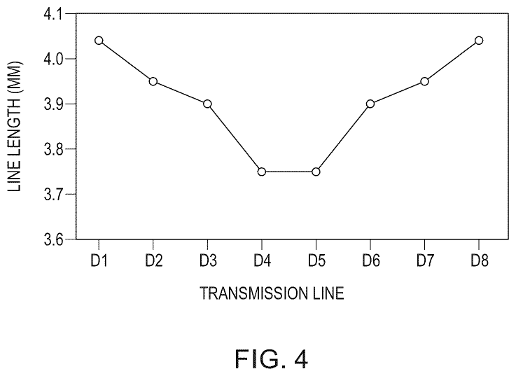

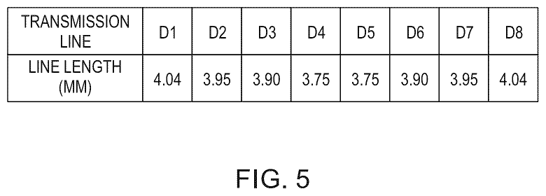

FIG. 4 illustrates a graphical representation of the plurality of line lengths of the plurality of respective transmission lines 61-68 of the series-connected patched array antenna 4A of FIG. 3. FIG. 5 illustrates a tabular representation of the plurality of line lengths of the plurality of respective transmission lines 61-68 of the series-connected patched array antenna 4A of FIG. 3. Therefore, line lengths D4 and D5 of transmission lines 64 and 65 located in the center in the X direction are shorter than the line lengths D3 and D6 of transmission lines 63 and 66 located outside in the X direction. The line lengths D3 and D6 of the transmission lines 63 and 66 are shorter than line lengths D2 and D7 of transmission lines 62 and 67 located outside in the X direction. The line lengths D2 and D7 of the transmission lines 62 and 67 are shorter than line lengths D1 and D8 of transmission lines 61 and 68 located outside in the X direction.

For example, focusing on the transmission line 64 located near the middle portion, and the transmission line 61 located near the end of the series-connected patched array antenna 4A, the difference between the width of the transmission line 64 and the width of the patched antennas 54 and 55 connected thereto is larger than the difference between the width of the transmission line 61 and the width of the patched antennas 51 and 52 connected thereto. Therefore, the line length D4 (for example, D4=3.75 mm) of the transmission line 64 is shorter than the line length D1 (for example, D1=4.04 mm) of the transmission line 61, and the decrease from the half wavelength (λ/2=4.04 mm) of the fundamental wave is large.

Furthermore, the difference between a width of a transmission line (for instance, the transmission line 64) and widths of connected patched antennas (for instance, the patched antennas 54 and 54) may be standardized for calculation purposes. In several embodiments, a standardized difference between the width of the transmission line 64 and the widths of the patched antennas 54 and 55 connected thereto, may be determined as a sum of the difference between the width of the transmission line 64 and the width of the patched antenna 54 connected to the X1 side of the transmission line 64, and the difference between the width of the transmission line 64 and the width of the patched antenna 55 connected to the X2 side of the transmission line 64. In several alternate embodiments, the standardized difference may be an average of the difference between the width of the transmission line 64 and the width of the patched antenna 54 connected to the X1 side of the transmission line 64, and the difference between the width of the transmission line 64 and the width of the patched antenna 55 connected to the X2 side of the transmission line 64.

As described above, the electromagnetic field disturbance occurs at the boundary between the plurality of patched antennas 51-59 and a plurality of the transmission lines 61-68. This electromagnetic field disturbance increases as the difference between the width of the plurality of patched antennas 51-59 and the width of the plurality of transmission lines 61-68 increases. When such electromagnetic field disturbance exists, effective line length(s) of the plurality of transmission lines 61-68 for a radio wave propagating through the plurality of transmission lines 61-68 in correlation with an amount of the electromagnetic field disturbance.

Therefore, to make the plurality of transmission lines 61-68 resonant, that is, to make the effective line length(s) of the plurality of transmission lines 61-68 close to half the wavelength of the fundamental wave, it is necessary to make the plurality of physical line lengths (also referred to as “the plurality of line lengths” in the context of the specification) of the plurality of respective transmission lines 61-68 shorter than the half wavelength of the fundamental wave. Therefore, in this embodiment, for each transmission line of the plurality of transmission lines 61-68, the physical line length of a transmission line (for example the transmission line 64) is made shorter than the half wavelength of the fundamental wave by an amount correlated with the difference between the width of the transmission line 64 and the widths of the patched antennas 55 and 56 connected to the transmission line 64.

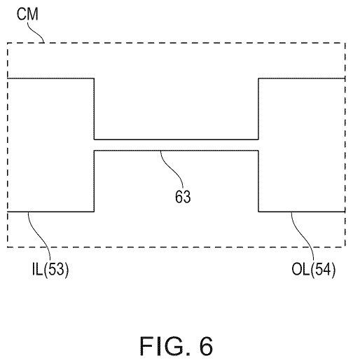

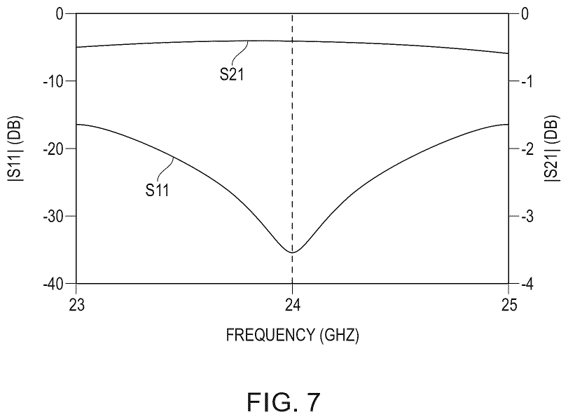

FIG. 6 illustrates an example of a Calculation Model (CM) for determining a line length of a transmission line (for example, a transmission line 63), in accordance with an embodiment of the present disclosure. FIG. 7 illustrates S11 (return loss) and S21 (transmission coefficient) in dB of the CM of FIG. 6. The calculation model CM represents a one-input-one-output circuit including the transmission line 63. An input side line IL has the same width as the patched antenna 53 connected to the X1 side of the transmission line 63. Furthermore, an output side line OL has the same width as the patched antenna 54 connected to the X2 side of the transmission line 63. The line length of the transmission line 63 is determined so that the transmission line 63 resonates with the fundamental wave by calculating an S parameter using the calculation model CM. In reference to FIG. 7, the line length of the transmission line 63 is determined so that S11 becomes minimum at the design frequency (24 GHz).

The line length of the transmission line 63 thus determined takes into account the disturbance of the electromagnetic field at the boundary between the transmission line 63 and the patched antennas 53 and 54. In other words, the effective line length of the transmission line 63 for the radio wave of the design frequency is half the wavelength of the fundamental wave. According to FIG. 5, the line lengths D1 and D8 (4.04 mm) of the transmission lines 61 and 68 are the same as the half wavelength of the fundamental wave (4.04 mm). This is because the electromagnetic field disturbance at the edges of the transmission lines 61 and 68 would be negligible.

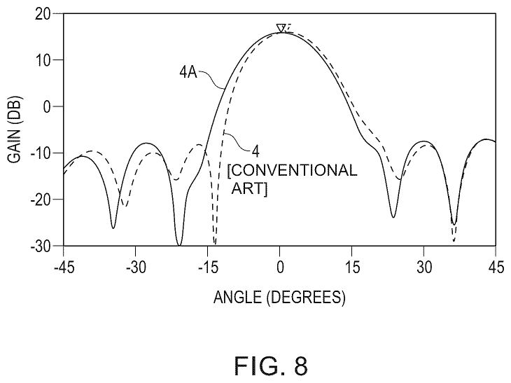

FIG. 8 illustrates radiation patterns of two different antenna designs, the series-connected patched array antenna 4A of FIG. 3, and the series-connected patched array antenna 4 of FIG. 2, showing their gain (in dB) versus angle (in degrees). Zero (0) degrees is the front face (Direction perpendicular to X, Y direction). In the series-connected patched array antenna 4A, the plurality of physical line lengths (or “the plurality of line lengths”) of the plurality of respective transmission lines 61-68 have been set in accordance with the description corresponding to FIGS. 5 and 6. In the series-connected patched array antenna 4 the plurality of line lengths of the plurality of respective transmission lines 61-68 are equal in accordance with the description corresponding to FIG. 2. Furthermore, the dimensions other than the line lengths are the same as those of the series-connected patched array antenna 4A. In that regard, in the series-connected patched array antenna 4, the maximum gain direction, in which the gain is maximum, deviates 1.6 degrees from the front, while in the series-connected patched array antenna 4A, the maximum gain direction is 0.4 degrees deviated from the front. Therefore, it is understood that in the series-connected patched array antenna 4A the maximum gain is radiated almost to the front.

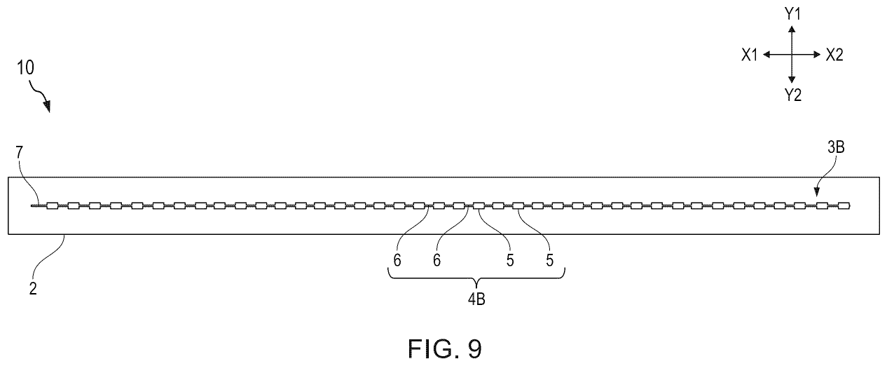

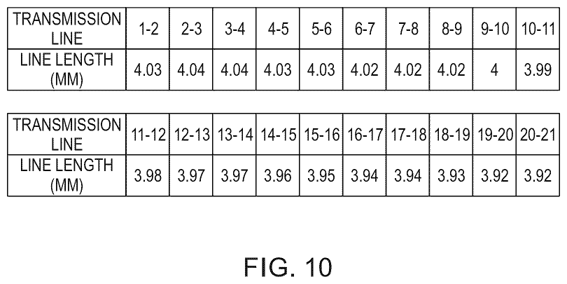

FIG. 9 illustrates a series-connected patched array antenna 4B, in accordance with another embodiment of the present disclosure. The series-connected patched array antenna 4B includes forty-one (41) patched antennas 5 and forty (40) transmission lines 6. FIG. 10 illustrates a tabular representation of the line lengths of the transmission lines 6 of the series-connected patched array antenna 4B of FIG. 9. In FIG. 10, the label “transmission line” indicates which two patched antennas of the patched antennas 5 a transmission line of the transmission lines 6 is connected between. For example, the transmission line “1-2” indicates the transmission line is connected between a first and a second patch antenna in the X1 towards X2 direction. Furthermore, FIG. 10 illustrates the line lengths of only the first twenty (20) transmission lines from the X1 towards the X2 direction.

The line lengths of the next twenty (20) transmission lines would be symmetrically distributed, as a mirror image, on the X2 side beyond the twenty-first (21^{st}) patch antenna. For instance, the line length of the transmission line “21-22” would be the same as the line length of the transmission line “20-21”, the line length of the transmission line “22-23” would be the same as the line length of the transmission line “19-20”, and so on until, the length of the transmission line “40-41” would be the same as the line length of the transmission line “1-2”. In the series-connected patched array antenna 4B, the line lengths of the transmission lines 6 are set so that larger the difference between the width of a transmission line and the widths of the two patched antennas (of the patched antennas 5) connected thereto, the larger the decrease in the line length of the transmission line, from the half wavelength of the fundamental wave.

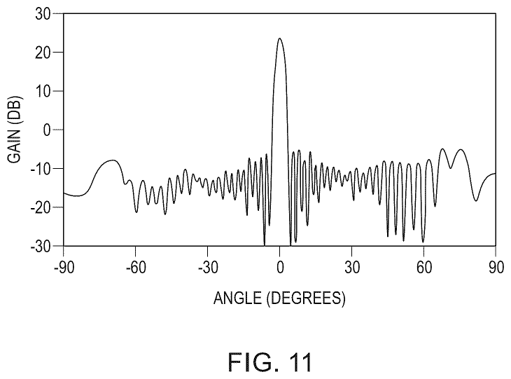

FIG. 11 illustrates a radiation pattern of the series-connected patched array antenna 4B of FIGS. 9 and 10. FIG. 11 depicts that the maximum gain direction is close to 0 degrees and the directivity in the front direction is high.

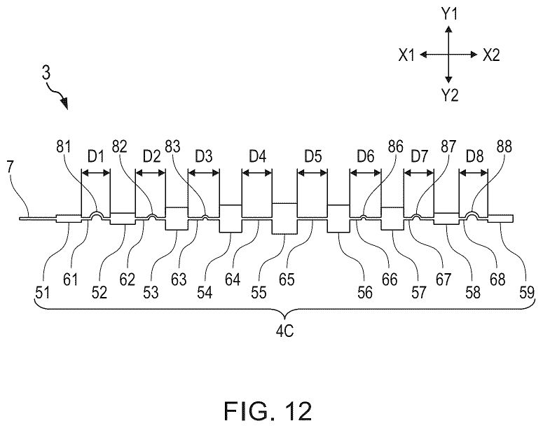

FIG. 12 illustrates a series-connected patched array antenna 4C, in accordance with another embodiment of the present disclosure. In the series-connected patched array antenna 4C, a predetermined number (six, 6) of transmission lines 61-63 and 66-68, of the plurality of transmission lines 61-68, have a predetermined number of respective curved portions 81-83 and 86-88. The length of each one of the predetermined number of curved portions 81-83 and 86-88 is correlated with the line length of a respective transmission line where the each one of the predetermined number of curved portions 81-83 and 86-88 is provided. Since the plurality of line lengths of the plurality of respective transmission lines 61-68 are longer closer to the end portions in the X direction and shorter closer to the middle portion in the X direction, the curved portions 81-83 and 86-88 are longer closer to the end portions, in the X direction and shorter in the middle portion, in the X direction. Furthermore, the transmission lines 64 and 65 closest to the center of the series-connected patched array antenna 4C in the X direction, are the shortest, and therefore, are not curved.

Thus, since the transmission lines 61-63 and 66-68 have curved portions 81-83 and 86-88, it is possible to set the line length of the transmission line 61-68 as described above and to bring the plurality of patched antennas 51-59 closer to equal displacements, while still keeping the lengths of the plurality of transmission lines 61-68 unequal in lengths. That is, the transmission lines 61-63 and 66-68 have curved portions 81-83 and 86-88 so that the plurality of patched antennas 51-59 are arranged at equal displacements. This makes it possible to narrow the beam width and improve the directivity. In the illustrated example, the curved portions 81-83 and 86-88 are curved in a U-shape, but they are not limited to this and maybe curved in an S-shape or the like.

Various embodiments of the disclosure, as discussed above, may be practiced with steps and/or operations in a different order, and/or with hardware elements in configurations, which are different than those which, are disclosed. Therefore, although the disclosure has been described based on these exemplary embodiments, it is noted that certain modifications, variations, and alternative constructions may be apparent and well within the spirit and scope of the disclosure.

Although various exemplary embodiments of the disclosure are described herein in a language specific to structural features and/or methodological acts, the subject matter defined in the appended claims is not necessarily limited to the specific features or acts described above. Rather, the specific features and acts described above are disclosed as exemplary forms of implementing the claims.

### Representative Embodiments of the Present Disclosure Will Be Listed Below;

(1) An antenna device, comprising: a dielectric substrate; and a series-connected patched array antenna comprising: a plurality of patched antennas aligned in a predetermined direction on the dielectric substrate and connected in series, and a plurality of transmission lines connecting adjacent patched antennas of the plurality of patched antennas, wherein, for each patched antenna of the plurality of patched antennas, a width of the patch antenna is different from a width of an adjacent patched antenna, on either side, in the predetermined direction, and wherein a plurality of line lengths of the plurality of respective transmission lines varies along the predetermined direction.
(2) The antenna device according to (1), wherein a line length of a transmission line, of the plurality of transmission lines, connecting adjacent patched antennas, of the plurality of patched antennas, is determined in correlation with widths of one or both of the two adjacent patched antennas connected to the transmission line.
(3) The antenna device according to (1) or (2), wherein a line length of a transmission line, of the plurality of transmission lines, connecting adjacent patched antennas, of the plurality of patched antennas, is determined in accordance with a width of a wider patched antenna of the two patched antennas connected to the transmission line.
(4) The antenna device according to any one of (1) to (3), wherein when a plurality of widths of the plurality of patched antennas increases progressively in the predetermined direction, the plurality of line lengths of the plurality of respective transmission lines are determined to progressively decrease in the predetermined direction.
(5) The antenna device according to any one of (1) to (3), wherein when a plurality of widths of the plurality of patched antennas decreases progressively in the predetermined direction, the plurality of lengths of the plurality of respective transmission lines are determined to progressively increase in the predetermined direction.
(6) The antenna device according to any one of (1) to (5), wherein a length of each transmission line, of the plurality of transmission lines, is shorter than half a wavelength of a fundamental wave by an amount correlated to a width of a patched antenna connected to the transmission line.
(7) The antenna device according to any one of (1) to (6), wherein a length of each transmission line, of the plurality of transmission lines, is shorter than half a wavelength of a fundamental wave by an amount correlated to the difference between: a width of a patched antenna connected to a first end of the transmission line, in the predetermined direction, and a width of another patched antenna connected to a second end, opposite to the first end, of the transmission line.
(8) The antenna device according to any one of (1) to (7), wherein a length of a transmission line, of the plurality of transmission lines, is determined to enable resonance with a fundamental wave, based on an S-parameter calculated by using a calculation model that comprises: the transmission line; an input line having a same width as a patched antenna connected to a first end of the transmission line, in the predetermined direction; and an output line having a same width as a patched antenna connected to a second end, opposite to the first end, of the transmission line.
(9) The antenna device according to (1), wherein a predetermined number of transmission lines, of the plurality of transmission lines, comprise a predetermined number of respective curved portions, length of each one of the predetermined number of curved portions is correlated with a line length of a respective transmission line where the each one of the predetermined number of curved portions is provided.
(10) The antenna device according to (1), wherein a predetermined number of transmission lines, of the plurality of transmission lines, comprise a predetermined number of respective curved portions configured to maintain equal displacements between adjacent patched antennas, of the plurality of patched antennas.
(11) A transmitter comprising the antenna device according to (1).
(12) A radar comprising the antenna device according to (1).

### REFERENCE SIGNS LIST

2: Dielectric Substrate, 21: First Main Surface, 3: Conductor Pattern, 4, 4A, 4B, 4C: Series-Connected Patched Array Antenna, 5, 51-59: Patched Antennas, 6, 61-68: Transmission Lines, 7: Input/Output Line, 9: Feeding Point; 81-83, 86-88: Curved Sections, 10: Antenna Device, 11: Transceiver Unit, 12: Signal Processing Unit, 13: Control Unit, 14: Processing Circuitry, 100: Radar, CM: Calculation Model.

What is claimed is:

1. An antenna device, comprising:
a dielectric substrate; and
a series-connected patched array antenna comprising:
a plurality of patched antennas aligned in a predetermined direction on the dielectric substrate and connected in series, and
a plurality of transmission lines connecting adjacent patched antennas of the plurality of patched antennas,
wherein, for each patched antenna of the plurality of patched antennas, a width of the patch antenna is different from a width of an adjacent patched antenna, on either side, in the predetermined direction, and
wherein a plurality of line lengths of the plurality of respective transmission lines varies along the predetermined direction.

2. The antenna device according to claim 1, wherein
a line length of a transmission line, of the plurality of transmission lines, connecting adjacent patched antennas, of the plurality of patched antennas, is determined in correlation with widths of one or both of the two adjacent patched antennas connected to the transmission line.

3. The antenna device according to claim 1, wherein
a line length of a transmission line, of the plurality of transmission lines, connecting adjacent patched antennas, of the plurality of patched antennas, is determined in accordance with a width of a wider patched antenna of the two patched antennas connected to the transmission line.

4. The antenna device according to claim 1, wherein
when a plurality of widths of the plurality of patched antennas increases progressively in the predetermined direction,
the plurality of line lengths of the plurality of respective transmission lines are determined to progressively decrease in the predetermined direction.

5. The antenna device according to claim 1, wherein
when a plurality of widths of the plurality of patched antennas decreases progressively in the predetermined direction,
the plurality of lengths of the plurality of respective transmission lines are determined to progressively increase in the predetermined direction.

6. The antenna device according to claim 1, wherein
a length of each transmission line, of the plurality of transmission lines, is shorter than half a wavelength of a fundamental wave by an amount correlated to a width of a patched antenna connected to the transmission line.

7. The antenna device according to claim 1, wherein
a length of each transmission line, of the plurality of transmission lines, is shorter than half a wavelength of a fundamental wave by an amount correlated to the difference between:
a width of a patched antenna connected to a first end of the transmission line, in the predetermined direction, and
a width of another patched antenna connected to a second end, opposite to the first end, of the transmission line.

8. The antenna device according to claim 1, wherein
a length of a transmission line, of the plurality of transmission lines, is determined to enable resonance with a fundamental wave, based on an S-parameter calculated by using a calculation model that comprises:
the transmission line;
an input line having a same width as a patched antenna connected to a first end of the transmission line, in the predetermined direction; and
an output line having a same width as a patched antenna connected to a second end, opposite to the first end, of the transmission line.

9. The antenna device according to claim 1, wherein
a predetermined number of transmission lines, of the plurality of transmission lines, comprise a predetermined number of respective curved portions, length of each one of the predetermined number of curved portions is correlated with a line length of a respective transmission line where the each one of the predetermined number of curved portions is provided.

10. The antenna device according to claim 1, wherein
a predetermined number of transmission lines, of the plurality of transmission lines, comprise a predetermined number of respective curved portions configured to maintain equal displacements between adjacent patched antennas, of the plurality of patched antennas.

11. A transmitter comprising the antenna device according to claim 1.

12. A radar comprising the antenna device according to claim 1.
